(19) United States
(12) Patent Application Publication
(10) Pub. No.: US 2018/0008883 A1
(43) Pub. Date: Jan. 11, 2018

(54) Last Peg Lose

(71) Applicant: Huey L. Carter, Compton, CA (US)

(72) Inventor: Huey L. Carter, Compton, CA (US)

(21) Appl. No.: 14/999,851

(22) Filed: Jul. 11, 2016

(51) Int. Cl. A63F 9/00; A63F 13/822; A63F 3/00

(52) U.S. Cl. CPC A63F 9/00; A63F 3/00697; A63F 13/822; A63F 2003/00709

(57) ABSTRACT

Last peg lose is a game played with two people. Each person takes turns moving. The flipping of a coin determines the first move. The game is designed for movement of pegs from each row. You may move as many pegs from one row at a time trying to leave your opponent with the last peg.

### FIELD OF THE INVENTION

The present invention pertains to the field of toys and games, and more specifically to the field of competitive board games.

### BACKGROUND OF THE INVENTION

The prior art has put forth several designs for competitive board games. Among these are:

U.S. Pat. No. 4,645,209 to Victor H. Goulter and Barbara W. Goulter describes a board game using an elevated board having fourteen rows, each of fourteen holes, so as to total ninety six holes. The board is divided into four quarters, each of forty nine holes, by lines into which two to four players play in turn, by placing colored playing pieces from swivel mounted storage drawers. Each player attempts to construct patterns to score points. Playing pieces have colors at one end for forming patterns and are reversible to a transparent end for cancellation after scoring by placing score pegs in appropriate holes. Color identification of inverted playing pieces is made possible through transparent end for visual score checking at any time. Each player also attempts to prevent his or her opponents from forming patterns by inserting a playing piece to block pattern formations. When four patterns are completed in first started quarter, a player can move into next quarter, but only if his or her first move completes or stops a pattern which straddles the border. Playing piece ends are shaped to be touch identifiable for blind players. Pattern shapes are permanent on board margin on the sides of board for international player reference.

U.S. Pat. No. 3,693,976 to Walter Flack describes a game apparatus comprising a board having a rectangular configuration with rows of uniformly spaced holes located at the intersection of lines forming a pattern of squares. The game is played by each player using a plurality of pieces, each piece consisting of two pegs fitting in the holes of the board and joined by a flexible inextensible link. The flexible link limits the ambit of movement of one peg relative to the other to the distance between alternate holes on a diagonal line. At the start of the game, each player's pieces are assembled in the first two rows of holes along opposite edges of the board. The objective of the game is for a player to move his pieces, one peg at a time across the board and to reassemble them similarly to the starting arrangement in the two rows of holes adjacent the opposite edge of the board.

U.S. Pat. No. 2,614,841 to Bernard Joseph describes a peg game board for use in playing a game of skill. The game comprises a board housing a plurality of depressible pegs arranged in groups in successive progression, starting with one peg and ending with a group of six or more. The game is usually played by two persons, each of whom in turn depresses one or more of the pegs in any group. If any peg of a group is depressed in any play then the remaining pegs of that group are considered as separate groups in the subsequent play or plays. For example, should the middle peg of the group of five be depressed then in following plays the remaining pegs of that group are treated as two independent groups until one or more of the pegs of such newly formed groups are depressed. While each player may depress at each turn as many pegs of a single group as he desires, he may not during that turn depress any peg or pegs of any other group or groups. The game may be played so that the person who depresses the last upstanding peg is considered the loser or the winner, as determined by the players before starting the game. Generally, the person who depresses the last peg is considered the loser.

None of these prior art references describe the present invention.

### SUMMARY OF THE INVENTION

It is an object of the present invention to provide a competitive game, played with pegs on a small pegboard, in which two players take turns removing pegs with the objective being to leave one's opponent with the last peg standing.

### BRIEF DESCRIPTION OF THE DRAWINGS

FIG. 1 is an illustrative prototypical view of the present invention showing a game board, pegs and a peg hole.

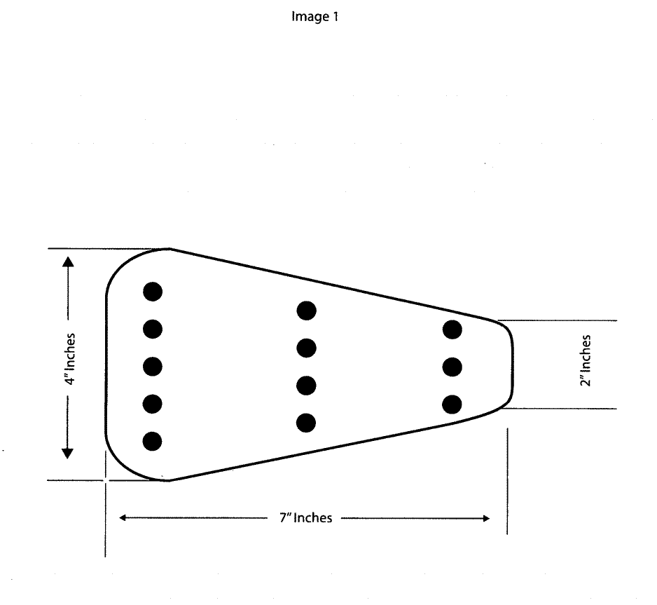

FIG. 2 is a functional top down view showing a game strategy of a key move in which two pegs are removed from the game board's first row of pegs.

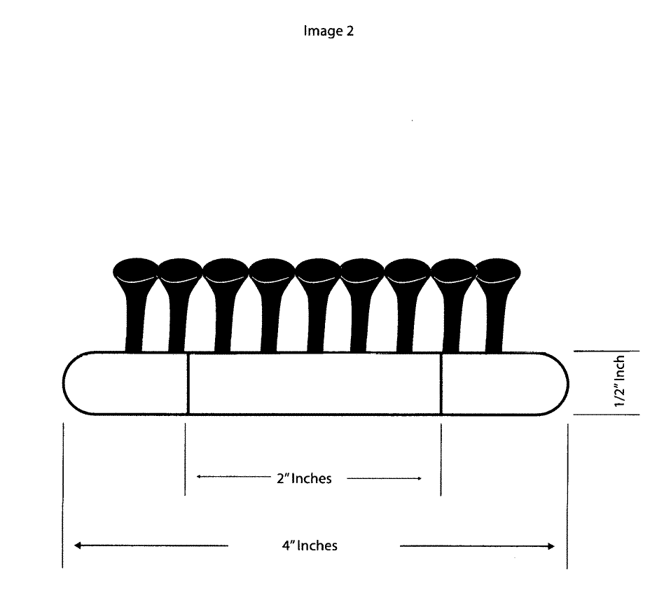

FIG. 3 is a functional top down view showing a game strategy of a key move which culminates in two pegs being removed from each row of pegs on the game board, leaving an opponent in a losing position.

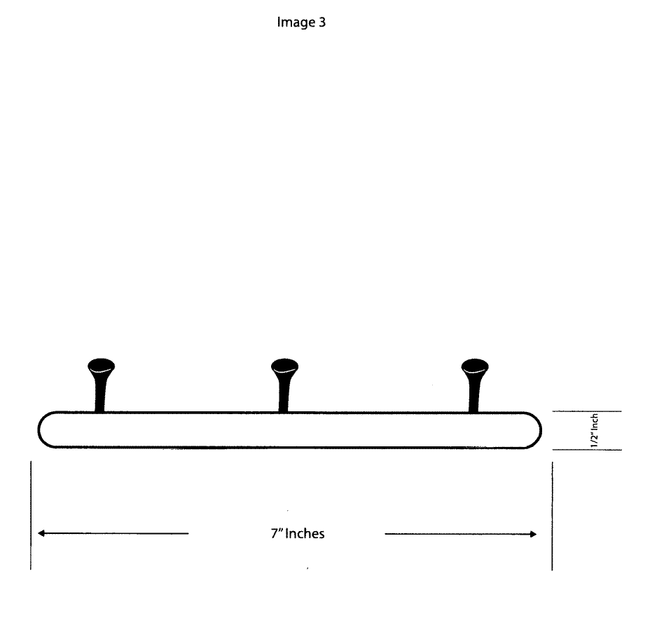

FIG. 4 is a functional top down view showing a game strategy of a key move which culminates in each row containing one remaining peg in the last position on the row, leaving an opponent in a losing position.

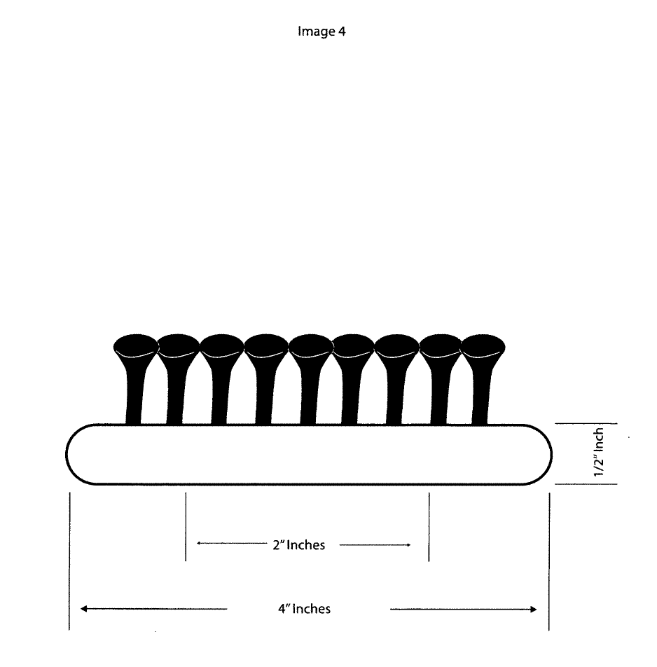

FIG. 5 is a functional top down view showing a game strategy of a key move which culminates in the first row containing two remaining pegs in the last two positions on the row, the second row containing two remaining pegs in the last two positions on the row, and the last row containing no pegs at all, leaving an opponent in a losing position.

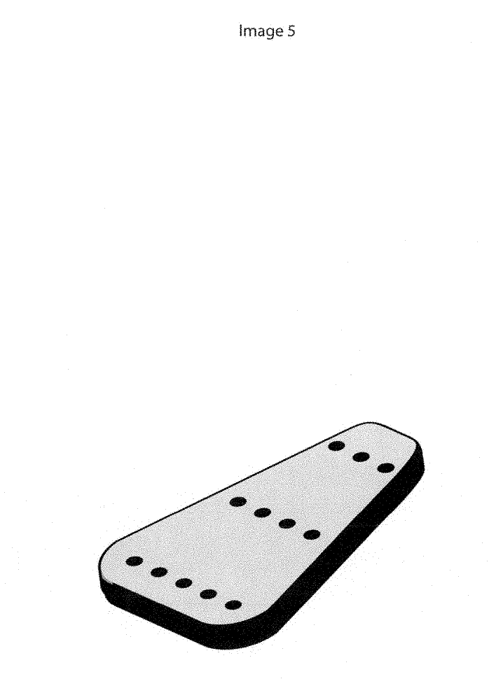

### DETAILED DESCRIPTION OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

Most everyone young and old, male and female, enjoys the challenge, entertainment and excitement of playing a competitive game. Games range from competitive athletic sports to cards, videogames, horseshoes, darts, board games, puzzles, and brain teasers. Some games, like chess, require great skill and a tremendous amount of practice and experience. Some games, like poker, combine developed skills with a large element of chance. Some games rely on pure chance for their sense of excitement and competition.

Some of the simplest, oldest and most traditional games remain the most popular. One game of enduring popularity is Tic Tac Toe which is endlessly playable with enjoyment on a sheet of paper, a smartphone, tablet computer or a magnetic travel game board. The peg board or tee game is a game of enduring popularity that often is found on a restaurant table for customer entertainment while waiting on food orders to arrive. This simple game is played with golf tee pegs on a wooden peg board is challenging and fun.

The present invention, hereinafter referred to as Last Peg Lose, is a competitive game for two players, played with approximately twelve pegs arranged in three rows on a small pegboard. Players take turns removing pegs, the object being to leave one's opponent with the last peg standing. Simple in concept but endlessly varied and challenging in play, Last Peg Lose is a fast moving, entertaining game for players of all ages. A physical embodiment of Last Peg Lose is played on a pegboard small enough for use in a car, on a plane or bus, or anywhere. A digital embodiment of Last Peg Lose is played on a pegboard and pegs that are displayed on a smartphone or computer.

The pegboard for the Last Peg Lose is trapezoidal in shape with top and bottom ends parallel to one another, and side borders converging slightly from bottom to top with rounded corners. The pegboard is produced in a variety of sizes, a larger size for table top play and a smaller size for travelling use. The pegboard is manufactured from milled, finished or unfinished wood or from molded thermoplastic. The game measures approximately four inches in bottom width, two and one half inches in top width, and eight inches in length.

The pegboard features three horizontal rows of holes. The top row contains three peg holes, the middle row contains four holes, and the bottom row contains five holes. The game begins with pegs occupying all the peg holes. The pegs are fabricated in milled wood or in plastic. The rules of Last Peg Lose are displayed on a sheet of paper glued to the bottom of the board or printed directly on the bottom of the board. The game is always played by two opposing players.

The rules and play Last Peg Lose are stated as follows. Start the game with all holes pegged. Flip a coin to determine which player moves first. Each player then moves in turn, pulling pegs from one of the three rows. Pegs can be drawn from only one row at each pull. A player may pull any number of pegs from a row on his turn, but cannot pull pegs from more than one row. The object, as the game proceeds, is to leave one's opponent with the last peg remaining on the board. When a player achieves this winning goal, the losing player then pulls the last peg lose from the last peg hole and audibly proclaims, Last Peg Lose! The pegs are repositioned in the holes for the next game.

Last Peg Lose is a deceptively simple game in which participating players must think ahead, calculating their moves and reacting to the moves of their opponents, implementing and altering strategies as the game continues. The game moves quickly and permits endless variations in play. Because one's own play depends largely on what one's opponent does, the Last Peg Lose remains entertaining and challenging, no matter how many times one plays it.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A competitive game, played with pegs on a small pegboard, in which two players take turns removing pegs with the objective being to leave one's opponent with the last peg standing, essentially as described herein.
